(19) United States
(12) Patent Application Publication
(10) Pub. No.: US 2025/0138207 A1
(43) Pub. Date: May 1, 2025

(54) COMPACT RADIATION DETECTION APPARATUS

(71) Applicant: FNC TECHNOLOGY CO., LTD., Yongin-si (KR)

(72) Inventors: Sang Hun SHIN, Yongin-si (KR); Hee Kwon KU, Hwaseong-si (KR); Min Beom HEO, Suwon-si (KR); Jae Wook KIM, Gyeongju-si (KR)

(73) Assignee: FNC TECHNOLOGY CO., LTD., Yongin-si (KR)

(21) Appl. No.: 18/389,688

(22) Filed: Dec. 19, 2023

(30) Foreign Application Priority Data
Oct. 31, 2023 (KR) 10-2023-0148126

(51) Int. Cl. G01T 7/04; G01T 1/36

(52) U.S. Cl. CPC G01T 7/04; G01T 1/36

(57) ABSTRACT

Disclosed is a technology related to a compact radiation detection apparatus used to measure airborne radiation. The compact radiation detection apparatus includes a cylindrical filter, a detector assembly coupled to one end of the cylindrical filter, and a pump assembly coupled to the other end of the cylindrical filter. Negative pressure is formed in an inner space in the cylindrical filter by a vacuum pump, and accordingly, aerosol is continuously collected on the surface of the cylindrical filter. A detector located in the inner space in the cylindrical filter detects radiation emitted from the collected aerosol.

### BACKGROUND OF THE INVENTION

### Field of the Invention

A technology related to a compact radiation detection apparatus used to measure radiation is disclosed.

### Description of the Related Art

As an example of methods of measuring radiation, there is a method of collecting aerosol through a filter that is operated by an air pump and measuring the collected aerosol using precise measurement equipment in a laboratory, thereby estimating a nuclide or analyzing an energy spectrum of radiation. However, this method has a limitation in that real-time measurement is impossible.

Korean patent registration No. 10-2327710, which was filed by the present applicant, discloses a detection apparatus that measures radiation while suctioning aerosol. Aerosol is collected through a filter, and radiation emitted from the collected aerosol is detected by a detector. This apparatus has an advantage of simultaneously measuring the concentration of aerosol and a radiation dose in real time. However, this apparatus is disadvantageous in terms of sensing efficiency because it has a structure in which a filter collects aerosol from air discharged from an outlet of an aerosol concentration sensor.

### SUMMARY OF THE INVENTION

The present invention has been made to solve the above problems, and it is an object of the present invention to improve the efficiency of a real-time airborne radiation detection apparatus.

It is another object of the present invention to provide a compact and lightweight real-time airborne radiation detection apparatus.

It is still another object of the present invention to propose a novel structure of a real-time airborne radiation detection apparatus having an aerosol collection function.

It is still another object of the present invention to propose an improved structure of a real-time airborne radiation detection apparatus having an aerosol collection function.

It is still another object of the present invention to provide a real-time airborne radiation detection apparatus that is convenient to maintain.

It is still another object of the present invention to propose a structure of a compact radiation detection apparatus that is usable as a sensor for Internet of Things in various environments.

In order to accomplish the above and other objects, according to one aspect of the present invention, negative pressure is formed by a pump in an inner space in a cylindrical filter, and a detector located in the inner space in the cylindrical filter detects radiation emitted from aerosol collected on the surface of the cylindrical filter due to flow of fluid formed by the negative pressure.

According to another aspect of the present invention, a pump assembly and a detector assembly may be detachably coupled to both ends of a filter unit, respectively.

According to another aspect of the present invention, a vacuum pump may be employed in order to form negative pressure in the inner space in the filter.

According to another aspect of the present invention, a detector may be supported and fixed such that the center of the surface of the detector is located near the center of the filter on the central axis of the filter having a cylindrical shape.

### BRIEF DESCRIPTION OF THE DRAWINGS

The above and other objects, features, and other advantages of the present invention will be more clearly understood from the following detailed description taken in conjunction with the accompanying drawings, in which:

FIG. 1 is a perspective view showing the external appearance of a compact radiation detection apparatus according to an embodiment;

FIG. 2 is a perspective view showing the configuration of a filter unit in the embodiment shown in FIG. 1;

FIG. 3 is a cross-sectional view showing the configuration of an embodiment of a pump assembly;

FIG. 4 is a perspective view showing an example of a detector assembly in the embodiment shown in FIG. 1; and

FIG. 5 is a view showing a cross-section of the filter unit cut along a plane passing through a central axis in the compact radiation detection apparatus according to an embodiment.

### DETAILED DESCRIPTION OF THE INVENTION

The foregoing and further aspects will be implemented through embodiments described with reference to the accompanying drawings below. It should be understood that components of each embodiment can be implemented in various combinations therein or with those of other embodiments, unless mentioned otherwise and as long as there is no contradiction between components. The terms used in the present specification and the claims should be interpreted as having meanings and concepts in accordance with the description herein or the proposed technical idea based on the principle that the inventors can appropriately define the concept of the terms to describe the invention in the best way. Hereinafter, exemplary embodiments of the present invention will be described in detail with reference to the accompanying drawings.

### <Description of Invention of Claim 1>

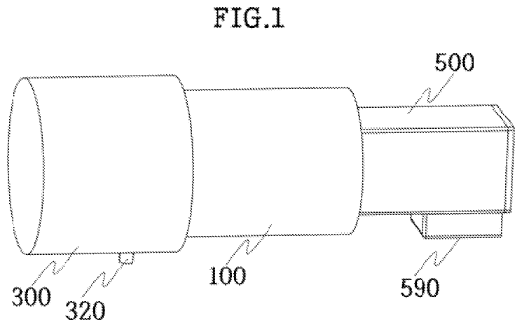

According to one aspect, negative pressure is formed by a pump in an inner space in a cylindrical filter, and a detector located in the inner space in the cylindrical filter detects radiation emitted from aerosol collected on the surface of the cylindrical filter. FIG. 1 is a perspective view showing the external appearance of a compact radiation detection apparatus according to an embodiment to which this aspect is applied. As illustrated, the compact radiation detection apparatus according to an embodiment includes a filter unit 100, a pump assembly 300, and a detector assembly 500.

The filter unit 100 has a cylindrical shape and includes a filter provided on at least a portion of the outer circumferential surface thereof. The pump assembly 300 is coupled to one end of the filter unit 100, and provides negative pressure to the filter unit 100. The detector assembly 500 is coupled to the other end of the filter unit 100, and detects radiation emitted from aerosol, which is collected in the filter of the filter unit 100 according to the negative pressure formed by the pump assembly 300, in the inner space in the filter unit 100.

### <Description of Invention of Claim 2>

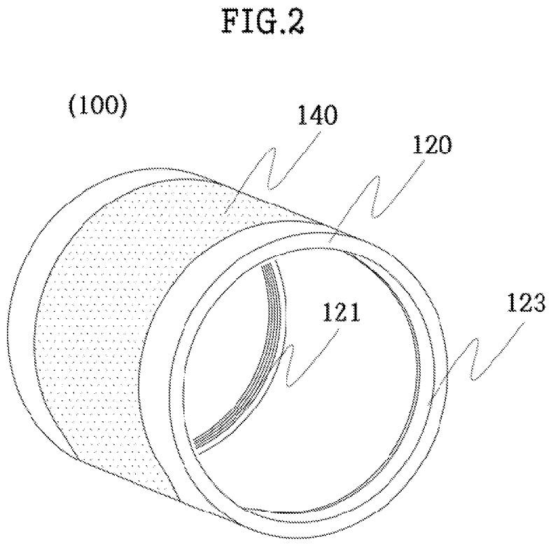

FIG. 2 is a perspective view showing the configuration of the filter unit in the embodiment shown in FIG. 1. In one embodiment, the filter unit 100 includes a cylindrical filter housing 120 and a filter 140 mounted on a portion of the outer circumferential surface of the filter housing 120. In the illustrated embodiment, the filter 140 is mounted in a wide area in the middle of the filter housing 120 except for outer circumferential surfaces of both end portions of the filter housing 120. The filter 140 may be one of a membrane filter, a pre-filter, a HEPA filter, and a medium filter. The filter housing 120 supports the filter 140 from the inner side so that the filter 140 withstands internal negative pressure.

### <Description of Invention of Claim 3>

According to another aspect of the invention, the pump assembly and the detector assembly may be detachably coupled to both ends of the filter unit, respectively. As illustrated, the filter unit 100 includes a pump coupling hole 121 formed in one end thereof to allow the pump assembly 300 to be coupled thereto and a detector coupling hole 123 formed in the other end thereof to allow the detector assembly 500 to be coupled thereto. The pump coupling hole 121 and the detector coupling hole 123 include thread grooves in which the pump assembly 300 and the detector assembly 500 are respectively threaded. In the illustrated embodiment, the pump coupling hole 121 is open.

### <Description of Invention of Claim 4>

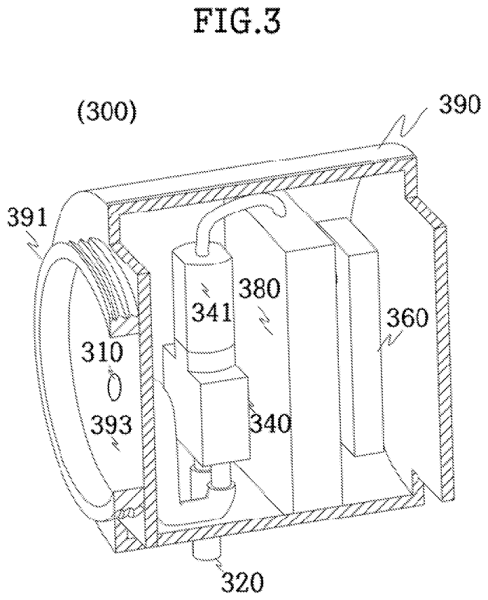

According to another aspect of the invention, a vacuum pump may be employed in order to provide negative pressure to the inner space in the filter. FIG. 3 is a cross-sectional view showing the configuration of an embodiment of the pump assembly to which this aspect is applied. As illustrated, the pump assembly 300 according to an embodiment includes a vacuum pump 340, a circuit board 360, and a battery 380.

The vacuum pump 340 pumps air from an air inlet port 310 to an air outlet port 320, thereby providing negative pressure to the inner space in the cylindrical filter. Due to the negative pressure formed in the inner space in the filter, aerosol is collected on the surface of the filter, and the collected aerosol is not desorbed. When a general pump is employed, if the amount of collected aerosol increases, the pump may stop, and thus the collected aerosol may be desorbed, or the amount of aerosol collected may be limited. A vacuum pump is advantageous for collecting aerosol for radiation measurement because the vacuum pump does not stop even when the amount of aerosol collected increases and the surface of the filter is partially clogged. A driving circuit for driving a motor 341 of the vacuum pump is formed on the circuit board 360. In addition, a power conversion circuit may be formed on the circuit board 360. In the illustrated embodiment, the battery 380 is a lithium-ion battery, and supplies power necessary for operation of the pump assembly 300. The vacuum pump 340 may be continuously driven until turned off, for example, even when the detector assembly 500 is separated from the filter unit 100.

### <Description of Invention of Claim 5>

The vacuum pump 340, the circuit board 360, and the battery 380 are fixed to and supported by the pump housing 390. In the illustrated embodiment, the pump housing 390 of the pump assembly 300 includes a first fastening portion 391 formed on one side thereof so as to be fastened to one end of the filter unit 100. In the illustrated embodiment, the first fastening portion 391 is threaded to the pump coupling hole 121 in the filter unit 100. In addition, a first partition wall 393 is formed at the first fastening portion 391 of the pump housing 390 in order to block the filter unit 100. A partition wall for blocking the filter unit 100 from the pump assembly 300 may be provided at the filter unit 100. For example, the partition wall may be provided in the pump coupling hole 121 in the filter unit 100. The air inlet port 310 is formed at the center of the first partition wall 393. The inlet of the vacuum pump 340 communicates with the air inlet port 310 through a pipe. The air outlet portion 320 is formed in the lower side of the pump housing 390 of the pump assembly 300. The outlet of the vacuum pump 340 communicates with the air outlet port 320 through a pipe.

### <Description of Invention of Claims 6 and 7>

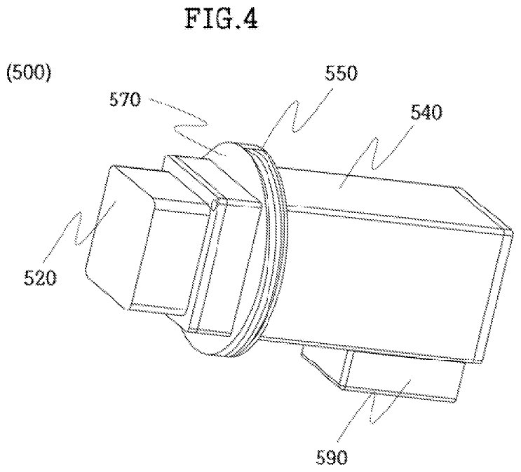

FIG. 4 is a perspective view showing an example of the detector assembly in the embodiment shown in FIG. 1. As illustrated, the detector assembly 500 according to an embodiment includes a detector 520 and a multichannel analyzer 540. In an embodiment, the detector 520 may be a CdZnTe (CZT) quasi-hemispherical detector. Among gamma ray detectors, a CZT detector is suitable for detection of gamma rays at room temperature, a Ge detector is suitable for high-resolution detection of gamma rays in a state of being cooled by liquid nitrogen, and a NaI detector is suitable for low-resolution detection of gamma rays. Since the present invention pursues a compact apparatus, a CZT detector is employed. This CZT detector is a small wideband semiconductor detector. The CZT detector has a cubic shape in consideration of the difficulty in forming a spherical shape of a hemispherical detector. The CZT detector has a structure in which a positive contact is provided on the center of a flat surface thereof and the remaining surfaces of the cube are grounded. An electric field is substantially radial and is very strong at a position near the positive contact, but gamma-ray capture occurs mostly over the remaining large surfaces of the cube. In an embodiment, the detector 520 is a DM500 CdZnTe detector manufactured by Ritec.

The multichannel analyzer (MCA) 540 generates radiation spectrum information from the output of the detector 520. The multichannel analyzer 540 may analyze a detection signal output from the detector 520 and may output a detection frequency of radiation having an energy value in a set range through each channel. In the illustrated embodiment, the multichannel analyzer 540 is an MCA527microE product manufactured by GBS Elektronic GmbH in Germany.

In the present embodiment, the multichannel analyzer 540 may operate in one of two modes: a pulse height analysis (PHA) mode and a multichannel scaling (MCS) mode. In the pulse height analysis (PHA) mode, a received pulse is characterized based on the amplitude (peak voltage) of a signal output from the detector. Each channel is allocated depending on the range of amplitude, and the output spectrum is a histogram of the number of pulses for each channel. In the multichannel scaling (MCS) mode, the multichannel analyzer 540 records a pulse count rate over time. Unlike the pulse height analysis (PHA), the multichannel scaling (MCS) does not distinguish between pulses of different amplitudes. Instead, the multichannel scaling (MCS) records all counts measured through one channel during a set time interval, and then switches to the next channel to record a subsequent time interval.

The detector assembly 500 is coupled to the other end of the filter unit 100. In the illustrated embodiment, the detector assembly 500 is coupled to the filter unit 100 in such a manner that a second fastening portion 550 thereof is threaded to the detector coupling hole 123 in the filter unit 100. In addition, a second partition wall 570 is formed at the second fastening portion 550 of the detector assembly 500 in order to block the filter unit 100. A partition wall for blocking the filter unit 100 from the detector assembly 500 may be provided at the filter unit 100. For example, the partition wall may be provided in the detector coupling hole 123 in the filter housing 120.

### <Description of Invention of Claim 8>

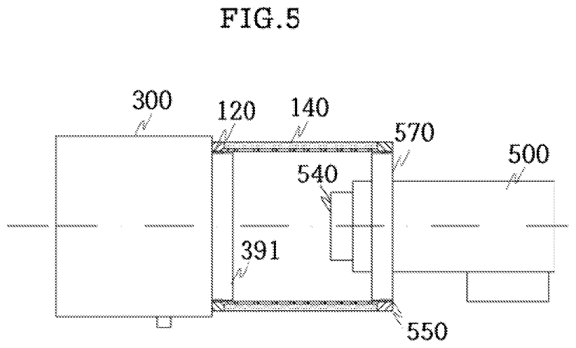

According to another aspect of the invention, the detector is supported and fixed such that the center of the surface of the detector is located near the center of the filter on the central axis of the filter having a cylindrical shape. In order to explain this aspect, FIG. 5 shows a cross-section of the filter unit 100 cut along a plane passing through the central axis in the compact radiation detection apparatus according to an embodiment. In order to increase the detection efficiency of the radiation detection apparatus, it is desirable for the detector assembly 500 and the filter unit 100 to have a positional relationship in which an average distance between the detection area of the detector assembly 500 and the inner surface of the filter 140 is minimized. In the present embodiment, since the detection area of the detector 520 is approximately hemispherical, it is desirable for the filter housing 120 to have a shape surrounding the detection area, i.e., a hemispherical shape, according to the shape of the detection area of the detector 520. However, since it is difficult to mount a hemispherical filter on the rear surface of the detector, the filter housing 120 may be formed to have a cylindrical shape or a truncated cone shape in the illustrated embodiment. As illustrated, the detector 520, which has a hexahedral shape, is supported and fixed such that the center of the surface of the detector 520 is located near the center of the filter housing 120 on the central axis of the filter housing 120 having a cylindrical shape. Accordingly, the center of the detection area of the detector 520 and the center of the inner circumferential surface of the filter housing 120 are aligned with each other on the central axis, and thus, detection efficiency may be improved.

### <Description of Invention of Claim 9>

In addition, the detector assembly 500 may further include a connector 590 configured to transmit output from the multichannel analyzer 540 to the outside. In the present embodiment, the multichannel analyzer 540 outputs data to the outside and receives operating power through the connector 590. In the illustrated embodiment, the connector 590 of the multichannel analyzer 540 supports a USB interface. For example, the connector 590 may be connected to a connector of a data collector of a radiation measurement post. In another example, the connector 590 may be connected to a connector of a communication modem of a drone.

As is apparent from the above description, according to the present invention, in order to achieve precise measurement, an aerosol collecting function and a real-time airborne radiation detection function may be implemented by a single apparatus having a structure that collects aerosol through a filter cylindrical communicating with a pump and detects radiation through a detector located in an inner space in the filter. Further, since the filter has a cylindrical shape suitable for the shape of the detection area of the detector, detection efficiency may be improved.

Further, according to the present invention, since a vacuum pump continuously operates even when a large amount of aerosol is collected in the filter, it may be possible to avoid failure of the pump or loss of the collected aerosol. In addition, since a pump assembly, a filter unit, and a detector assembly are detachably coupled to each other, it may be possible to conveniently perform precise measurement of collected aerosol by separating the filter unit and to facilitate maintenance of parts when the parts fail or reach the end of their lifespan.

Further, since the present invention proposes a structure suitable for a compact and lightweight airborne radiation detection apparatus, the detection apparatus according to the present invention may be loaded in a drone, which is sensitive to loading weight.

Although the preferred embodiments of the present invention have been disclosed for illustrative purposes, those skilled in the art will appreciate that various modifications, additions and substitutions are possible, without departing from the scope and spirit of the invention as disclosed in the appended claims.

What is claimed is:

1. A compact radiation detection apparatus comprising:
a filter unit having a cylindrical shape and comprising a filter provided on at least a portion of an outer circumferential surface thereof;
a pump assembly coupled to one end of the filter unit, the pump assembly being configured to provide negative pressure to the filter unit; and
a detector assembly coupled to another end of the filter unit, the detector assembly being configured to detect radiation emitted from aerosol, collected in the filter of the filter unit according to negative pressure formed by the pump assembly, in an inner space in the filter unit.

2. The compact radiation detection apparatus according to claim 1, wherein the filter is one of a membrane filter, a pre-filter, a HEPA filter, and a medium filter, and
wherein the filter unit further comprises a cylindrical filter housing configured to support the filter against internal negative pressure.

3. The compact radiation detection apparatus according to claim 1, wherein the pump assembly and the detector assembly are detachably coupled to the one end and the other end of the filter unit, respectively.

4. The compact radiation detection apparatus according to claim 1, wherein the pump assembly comprises:
a vacuum pump;
a circuit board having a driving circuit formed thereon to drive the vacuum pump; and
a battery.

5. The compact radiation detection apparatus according to claim 4, wherein the pump assembly comprises a pump housing comprising a first fastening portion formed to be fastened to one end of the filter unit, an air inlet portion formed in the first fastening portion, and an air outlet portion formed in a lower side thereof, and
wherein the pump housing supports and fixes the vacuum pump, the circuit board, and the battery in an inner space thereof.

6. The compact radiation detection apparatus according to claim 1, wherein the detector assembly comprises:
a detector; and
a multichannel analyzer configured to generate radiation spectrum information from output of the detector.

7. The compact radiation detection apparatus according to claim 6, wherein the detector is a CZT quasi-hemispherical detector.

8. The compact radiation detection apparatus according to claim 7, wherein the detector is supported and fixed such that a center of a surface of the detector is located near a center of the filter unit on a central axis of the filter unit having a cylindrical shape.

9. The compact radiation detection apparatus according to claim 1, wherein the detector assembly further comprises a connector configured to transmit output from a multichannel analyzer to an outside.
